(19) United States
(12) Patent Application Publication
(10) Pub. No.: US 2017/0281456 A1
(43) Pub. Date: Oct. 5, 2017

(54) MASSAGING DEVICE

(71) Applicant: Paul CHEN, Vancouver (CA)

(72) Inventor: Paul CHEN, Vancouver (CA)

(21) Appl. No.: 15/083,433

(22) Filed: Mar. 29, 2016

(51) Int. Cl. A61H 15/00; A61H 1/00; A61H 7/00

(52) U.S. Cl. CPC A61H 15/0092; A61H 7/001; A61H 1/008

(57) ABSTRACT

A massaging device includes two caps, and a number of beams disposed between the caps and secured to the caps, and the beams each include a number of massaging projections for massaging purposes. A housing is slidably disposed between the caps and movable between the caps, the housing includes a number of massaging members. The housing includes a number of slots for slidably engaging with the beams respectively. The housing includes a chamber, and the caps each include a tubular element extended and engaged into the chamber of the housing. The housing includes a cavity formed in each of two end portions of the housing, and the caps each include a catch for engaging with the cavity of the housing.

### BACKGROUND OF THE INVENTION

1. Field of the Invention

The present invention relates to a massaging device, and more particularly to a massaging device including an improved and simplified structure or configuration that may be easily and quickly made or manufactured or assembled by the workers and including an adjustable structure or configuration for adjusting the arrangement of the massaging members and for adjusting the massaging effects to the users.

2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape, and a relatively softer or resilient outer layer for selectively contacting or engaging with the users and for massaging purposes.

However, the outer layer includes a smooth outer peripheral structure or contour that may not be frictionally contacted or engaged with the users such that the users may not be massaged with the typical massaging devices.

U.S. Pat. No. 8,888,808 to Park discloses another typical massaging device comprising a planar base member having a number of projections or protrusions extended outwardly therefrom for frictionally contacting or engaging with the users and for massaging purposes.

However, the projections or protrusions extended outwardly from the planar base member, but may not be adjusted relative to the planar base member, and thus may not provide different massaging forces or effects to the users. In addition, the projections or protrusions extended outwardly from the planar base member include a single hardness that may not be changed to different hardnesses.

The present invention has arisen to mitigate and/or obviate the afore-described disadvantages of the conventional massaging devices.

### SUMMARY OF THE INVENTION

The primary objective of the present invention is to provide a massaging device including an improved and simplified structure or configuration that may be easily and quickly made or manufactured or assembled by the workers.

The other objective of the present invention is to provide a massaging device including an adjustable structure or configuration for adjusting the arrangement of the massaging members and for adjusting the massaging effects to the users.

The further objective of the present invention is to provide a massaging device including a number of massaging projections and/or massaging members having different hardnesses for providing different massaging effects to the users.

In accordance with one aspect of the invention, there is provided a

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massaging device in accordance with the present invention;

FIGS. 2, 3 are other perspective views similar to FIG. 1, illustrating the operation of the massaging device;

FIG. 4 is an exploded view as seen from one direction of the massaging device;

FIG. 5 is another exploded view as seen from the other direction of the massaging device; and

FIGS. 6, 7, 8 are cross sectional views of the massaging device, taken along lines 6-6, 7-7, 8-8 of FIGS. 1, 2, 3 respectively, illustrating the operation of the massaging device.

### DETAILED DESCRIPTION OF THE PREFERRED EMBODIMENT

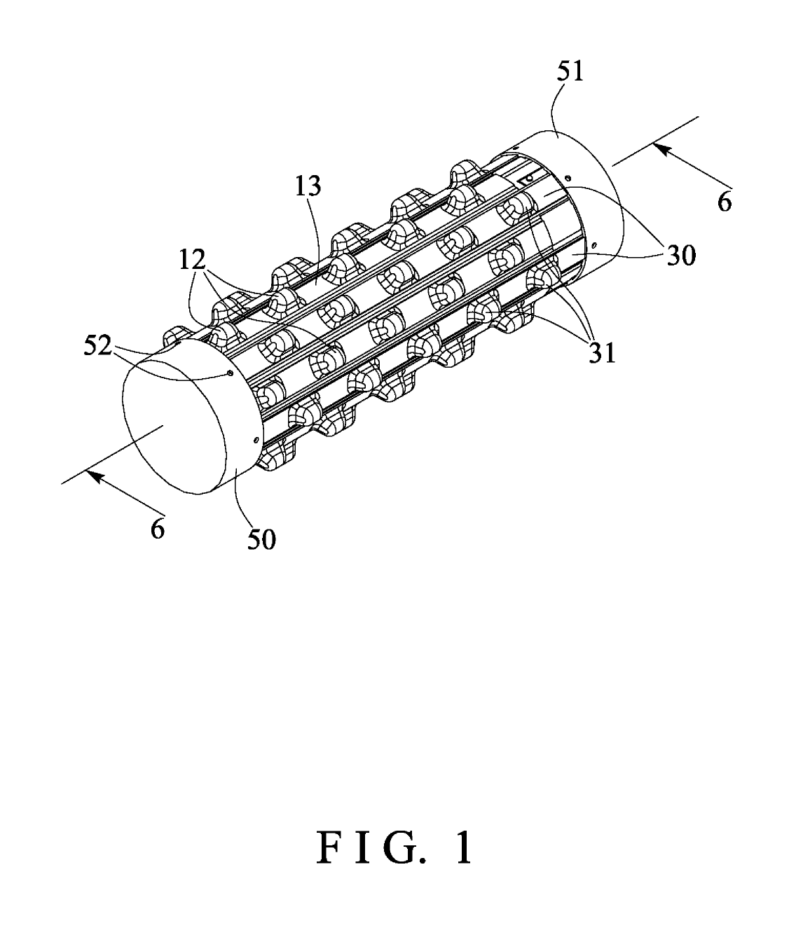

Referring to the drawings, and initially to FIGS. 1-6, a massaging device in accordance with the present invention comprises an outer receptacle or housing 10 made of a relatively harder or stronger materials, such as plastic, wood, metal, synthetic materials or the like, the housing 10 preferably includes a cylindrical shape or contour having a bore or inner compartment or chamber 11 formed therein, and includes a number of massaging members 12, such as five rows of massaging members 12 extended radially and outwardly therefrom. For example, a number of bars 13, such as six bars 13 are provided and solidly and stably attached or mounted or secured onto the housing 10 with fasteners, screws, welders or adhesive materials or the like, and equally spaced from each other, and preferably parallel to each other, and the massaging members 12 are extended radially and outwardly from the bars 13 respectively for allowing the massaging members 12 of the bars 13 to be made of a softer material than that of the housing 10. It is to be noted that the massaging members 12 may also be directly extended or molded or formed on the housing 10 without the bars 13.

The housing 10 further includes a number of (such as six) slots 14 formed therein, such as formed in the outer peripheral portion of the housing 10 and parallel to each other, and the slots 14 are preferably selected from dovetail slots 14 and arranged and located between the massaging members 12 and/or the bars 13 for movably or slidably receiving or engaging with the beams 30 respectively; i.e., the beams 30 are movably or slidably received or engaged in the slots 14 of the housing 10 respectively, it is preferable that the beams 30 are spaced from each other and parallel to each other, and are selected from dovetail beams 30, and the beams 30 each include a number of massaging projections 31 extended radially and outwardly therefrom, and the massaging members 12 and the massaging projections 31 are made of a relatively softer or resilient material, such as plastic, synthetic materials, rubber or the like for softly and comfortably contacting or engaging with the users and for massaging purposes.

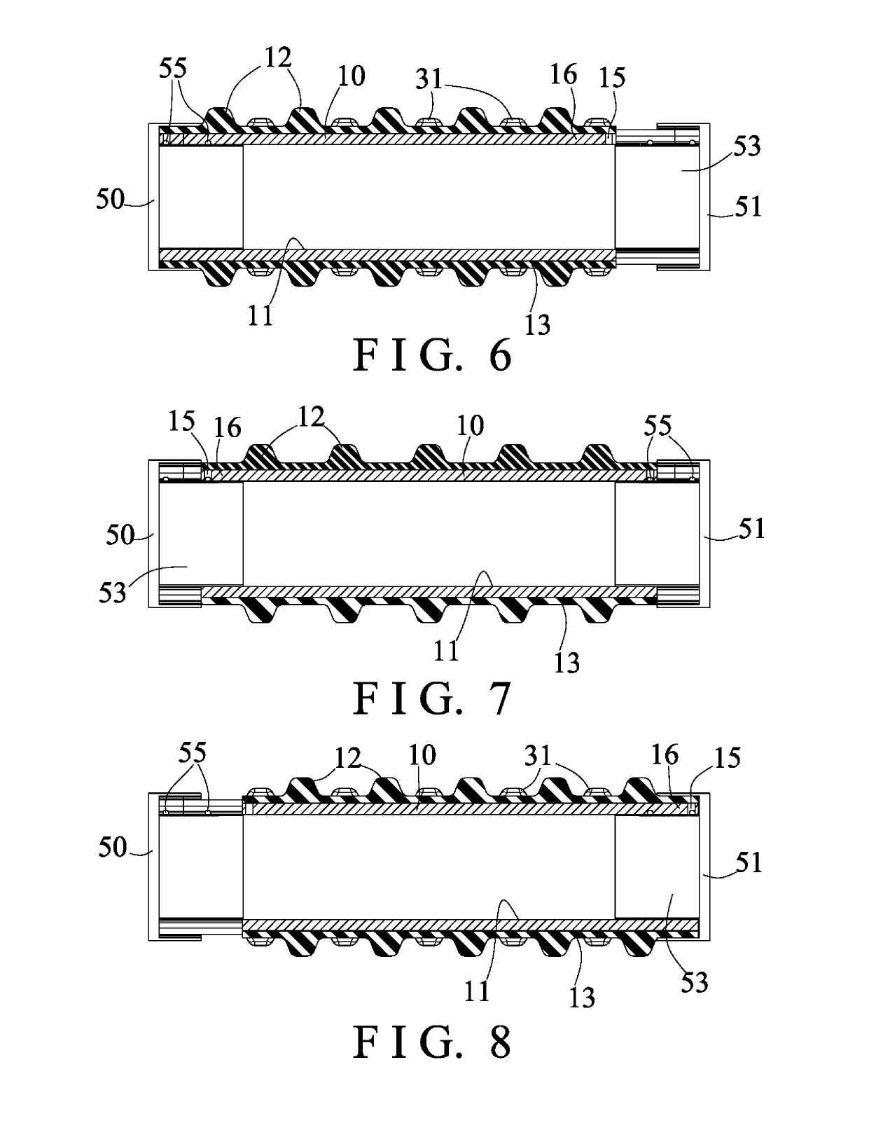

In addition, as shown in FIGS. 6-8, the massaging members 12 on or at some of the bars 13 may include a hardness different from that of the other massaging members 12 on or at the other bars 13; or the massaging members 12 and the bars 13 may include a different hardness from that of the other massaging members 12 and the other bars 13; and the massaging projections 31 on or at some of the beams 30 may include a hardness different from that of the other massaging projections 31 on or at the other beams 30; or the massaging projections 31 and the beams 30 may include a different hardness from that of the other massaging projections 31 and the other beams 30 for providing different massaging effects to the users. Accordingly, in one of the massaging devices, the massaging members 12 and the bars 13, and the massaging projections 31 and the beams 30 may include a single hardness, or may include a hardness different from each other for providing different massaging effects to the users.

Two covers or caps 50, 51 are disposed on the end portions of the beams 30 and mounted or secured to the beams 30 with screws or bolts or catches or latches or fasteners 52 or the like (FIGS. 1-3); i.e., the beams 30 are secured between the caps 50, 51 and are preferably spaced from each other and parallel to each other. It is preferable, but not necessary that the caps 50, 51 each include a barrel or tubular member or element 53 extended therefrom and slidably engaged into the chamber 11 of the housing 10 for anchoring or retaining or positioning the housing 10 between the caps 50, 51. The beams 30 include a length greater than that of the housing 10, and the beams 30 are solidly and stably mounted or secured between the caps 50, 51 for allowing the housing 10 to be moved or slid relative to the beams 30 and the caps 50, 51 to be limited to move or slide between the caps 50, 51, best shown in FIGS. 1-3 and 6-8.

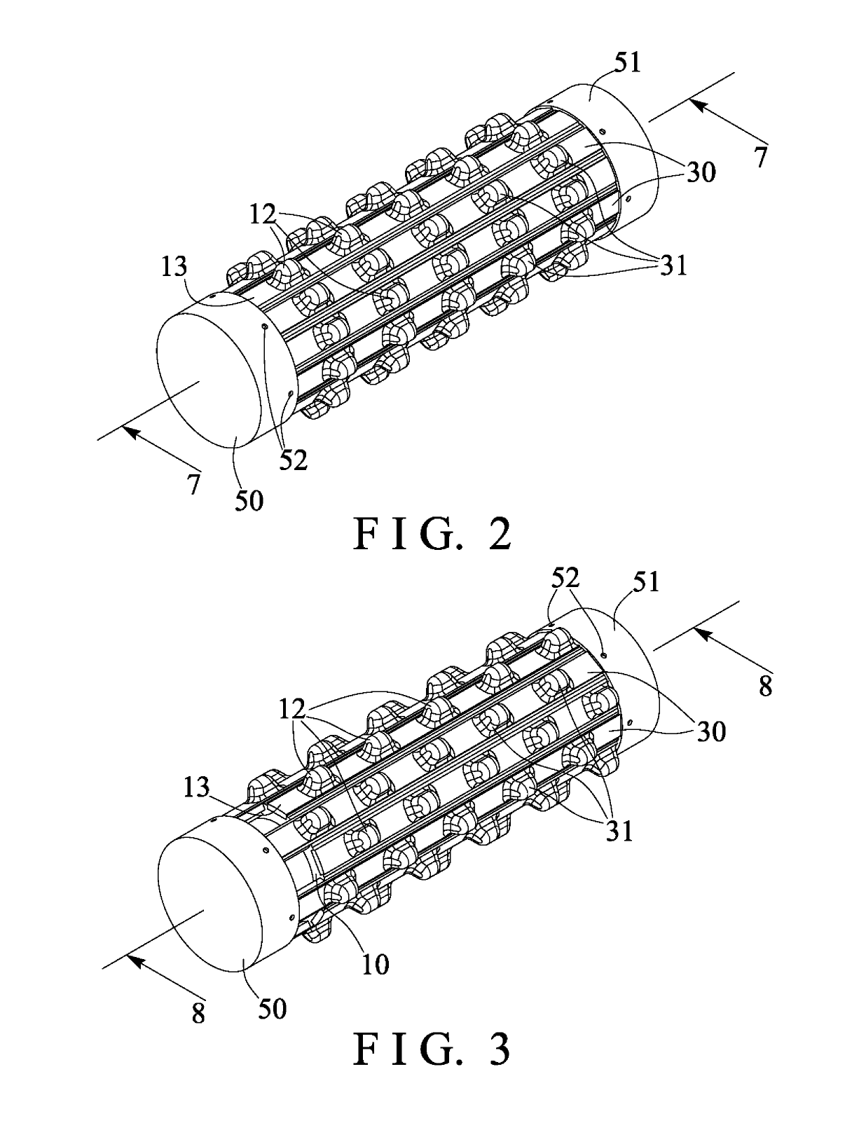

In operation, as shown in FIGS. 2 and 7, when the housing 10 is moved relative to the beams 30 and moved to the middle or intermediate portion between the caps 50, 51, the massaging members 12 of the bars 13 or of the housing 10 and the massaging projections 31 of the beams 30 may be located beside each other for forming or defining several (such as five) rounds or circles of massaging members and projections 12, 31 and for providing a massaging effect to the user. As shown in FIGS. 1 and 6, the housing 10 and thus the massaging members 12 of the bars 13 may be moved or adjusted leftward relative to the beams 30 and the caps 50, 51 for allowing the massaging members 12 of the bars 13 to be moved away from the massaging projections 31 of the beams 30 and to be arranged in a stagger way relative to each other, and for providing a massaging effect different from that shown in FIGS. 2 and 7.

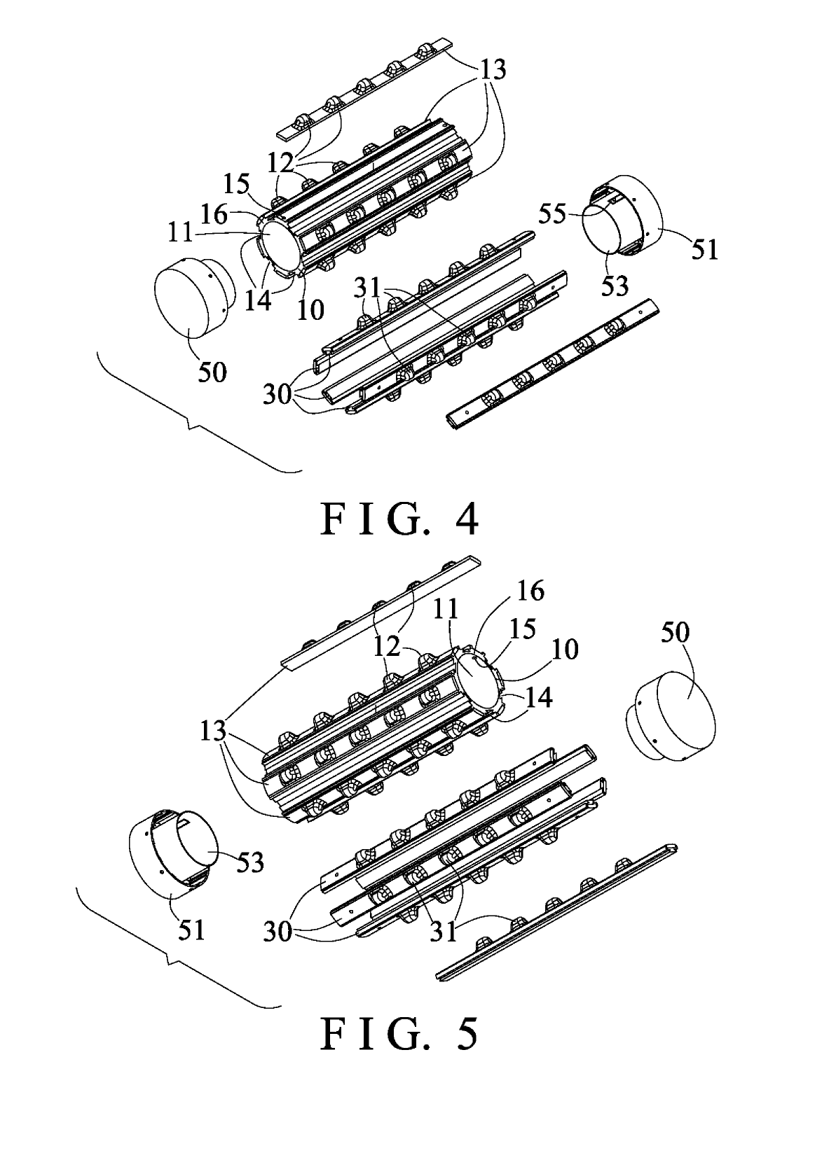

Similarly, as shown in FIGS. 3 and 8, the housing 10 and thus the massaging members 12 of the bars 13 may also be moved rightward relative to the beams 30 and the caps 50, 51 for allowing the massaging members 12 of the bars 13 also to be moved away from the massaging projections 31 of the beams 30 and to be arranged in a stagger way relative to each other, and for providing a massaging effect different from that shown in FIGS. 2 and 7. The housing 10 may include a cavity 15 formed in each of the end portions 16 of the housing 10 (FIGS. 4-8), and the caps 50, 51 each may include one or more (such as two) spring biased projections or catches 55 (FIGS. 6-8) extended therefrom, such as extended from the tubular element 53 for selectively engaging with the cavities 15 of the housing 10 and for anchoring or retaining or positioning the housing 10 to the caps 50, 51 at the selected or required position or location.

Accordingly, the massaging device in accordance with the present invention includes an improved and simplified structure or configuration that may be easily and quickly made or manufactured or assembled by the workers, and includes an adjustable structure or configuration for adjusting the status or arrangement of the massaging members and for adjusting the massaging effects to the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a plurality of beams spaced from each other, and said beams each including a plurality of massaging projections extended therefrom, said massaging projections including a hardness different from each other.

2. The massaging device as claimed in claim 1 further comprising two caps, and said beams are disposed between said caps and secured to said caps.

3. The massaging device as claimed in claim 2 further comprising a housing slidably disposed between said caps and movable between said caps, said housing including a plurality of massaging members extended therefrom.

4. The massaging device as claimed in claim 3, wherein said massaging members of said housing include a hardness different from each other.

5. The massaging device as claimed in claim 3, wherein said housing includes a plurality of slots formed therein for slidably engaging with said beams respectively.

6. The massaging device as claimed in claim 5, wherein said slots of said housing are selected from dovetail slots, and said beams are selected from dovetail beams and are slidably engaged with said dovetail slots of said housing respectively.

7. The massaging device as claimed in claim 3, wherein said housing includes a chamber formed therein, and said caps each include a tubular element extended therefrom and engaged into said chamber of said housing.

8. The massaging device as claimed in claim 3, wherein said caps each include at least one catch extended therefrom for selectively engaging with said housing and for anchoring said housing to said caps at selected locations.

9. The massaging device as claimed in claim 8, wherein said housing includes a cavity formed in each of two end portions of said housing for selectively engaging with said at least one catch of said cap.

10. The massaging device as claimed in claim 8, wherein said at least one catch of said cap is selected from a spring biased catch.

11. The massaging device as claimed in claim 3, wherein said housing includes a plurality of bars attached thereto, and said massaging members are extended from said bars respectively.
